(19) United States
(12) Patent Application Publication
(10) Pub. No.: US 2025/0247134 A1
(43) Pub. Date: Jul. 31, 2025

(54) PROCEDURES FOR HYBRID BEAMFORMING IN WIRELESS SYSTEMS

(71) Applicant: InterDigital Patent Holdings, Inc., Wilmington, DE (US)

(72) Inventors: Mohamed Salah Ibrahim, Chesterbrook, PA (US); Arnab Roy, Phoenixville, PA (US); Akshay Malhotra, San Jose, CA (US); Shahab Hamidi-Rad, Sunnyvale, CA (US); Mihaela Beluri, Jericho, NY (US)

(73) Assignee: InterDigital Patent Holdings, Inc., Wilmington, DE (US)

(21) Appl. No.: 18/856,733

(22) PCT Filed: Apr. 14, 2023
(86) PCT No.: PCT/US23/18673

§ 371 Date: Oct. 14, 2024

Related U.S. Application Data
(60) Provisional application No. 63/331,026, filed on Apr. 14, 2022.
(60) Provisional application No. 63/488,265, filed on Mar. 3, 2023.

(51) Int. Cl. H04B 7/06; H04B 7/0456; H04W 24/10

(52) U.S. Cl. CPC H04B 7/0617; H04B 7/0456; H04W 24/10

(57) ABSTRACT

Disclosed is a system and method implemented in a wireless transmit/receive unit (WTRU) for hybrid beamforming (HBF) in a wireless environment. The WTRU may be configured to receive an indication associated with enabling an HBF Type recommendation and/or receive a configuration associated with HBF processing. The WTRU may determine a channel matrix associated with a sub-band, determine one or more feedback overhead information, and/or determine one or more HBF precoders. The WTRU may determine a preferred HBF type based on a preconfigured set of parameters that is associated with the configuration related to HBF processing, and/or determine a set of Vandermonde phases based on the preconfigured set of parameters that is associated with the configuration related to HBF processing. The WTRU may report HBF information and/or angles associated with quantization information to a base station. The WTRU may receive a second configuration.

### CROSS REFERENCE TO RELATED APPLICATIONS

This application claims the benefit of U.S. Provisional Patent Application No. 63/331,026, filed Apr. 14, 2022 and U.S. Provisional Application No. 63/488,265, filed Mar. 3, 2023, the entire contents of which are incorporated herein by reference.

### BACKGROUND

Aspects of the present disclosure relate to beamforming, and more particularly, to procedures for hybrid beamforming for a Wireless Transmit/Receive Unit (WTRU) in a wireless system.

Wireless access systems have been widely deployed to provide various types of communication services such as voice or data. A wireless access system may be a multiple access system that supports communication of multiple users by sharing available system resources (e.g., a bandwidth, transmission power, etc.) among them.

For example, multiple access systems may include a Code Division Multiple Access (CDMA) system, a Frequency Division Multiple Access (FDMA) system, a Time Division Multiple Access (TDMA) system, an Orthogonal Frequency Division Multiple Access (OFDMA) system, and a Single Carrier Frequency Division Multiple Access (SC-FDMA) system.

### BRIEF SUMMARY

Example embodiments in the disclosure relate to a Wireless Transmit/Receive Unit (WTRU) that may be configured to receive an indication associated with enabling a hybrid beamforming (HBF) Type recommendation and/or receive a configuration related to HBF processing. In some examples, the WTRU may be configured to determine a channel matrix associated with a sub-band. Alternatively, or additionally, the WTRU may be configured to determine one or more feedback overhead information. Alternatively, or additionally, the WTRU may be configured to determine one or more hybrid beamforming (HBF) precoders. HBF precoders may be associated with the one or more feedback overhead information.

The WTRU may be configured to determine a preferred HBF type, for example based on a preconfigured set of parameters. The preconfigured set of parameters may be associated with the configuration related to HBF processing. The WTRU may be configured to determine a set of Vandermonde phases, for example based on the preconfigured set of parameters.

In an example, the WTRU may be configured to report HBF information and/or to report angles associated with quantization information. The WTRU may report the HBF information and/or angles associated with quantization information to a base station.

A WTRU may determine at least one constraint related to processing performance or feedback overhead associated with each of a plurality of hybrid beamforming (HBF) types. The WTRU may be configured to, based on a configuration related to HBF processing and the at least one constraint related to processing performance or feedback overhead associated with each of the plurality of HBF types, report to a base station HBF information related to the preferred HBF type of the plurality of HBF types and associated parameters. The HBF information may indicate at least one of the preferred HBF Type, an HBF precoder associated with the preferred HBF type, or an effective rank associated with the preferred HBF type. The WTRU may be configured to determine a channel matrix associated with a sub-band, derive one or more HBF precoders using the channel matrix, and/or determine the preferred HBF type based on a preconfigured set of parameters that is associated with the configuration related to HBF processing. The HBF precoders may be associated with the at least one constraint related to processing performance or feedback overhead. One of the HBF types may include a Vandermonde structure. The configuration may include a first configuration. The preferred HBF type may include a first preferred HBF type. The WTRU may be configured to receive a second configuration related to a hybrid beamforming (HBF) processing, and/or based on the second configuration related to the HBF processing and the at least one constraint related to processing performance or feedback overhead associated with each of the plurality of HBF types, switch from the first preferred HBF type to a second preferred HBF type of the plurality of HBF types, and/or report to the base station second HBF information related to the second preferred HBF type of the plurality of HBF types and associated parameters. The second HBF information may indicate at least one of the second preferred HBF Type, an HBF precoder associated with the second preferred HBF type, or an effective rank associated with the second preferred HBF type. Reporting to the base station may include reporting a Vandermonde based codebook derived from one or more measurements made by the WTRU. Switching from the from the first preferred HBF type to a second preferred HBF type of the plurality of HBF types may be based on a trigger event. The trigger event may include satisfying one or more of a performance threshold value, a threshold associated with a monitored value, and a preconfigured condition. The WTRU may be configured to receive a configuration related to HBF processing. The WTRU may be configured to derive the configuration related to HBF processing, for example based on one or more measurements made by the WTRU. The WTRU may be configured to derive one or more HBF precoders using the channel matrix. The HBF precoders may be associated with the at least one constraint related to processing performance or feedback overhead. The constraint may include a measured angle. The WTRU may receive a second configuration. The second configuration may be received from a base station. The second configuration may include one or more of a the preferred HBF type, an HBF precoder associated with the preferred HBF type, an effective rank associated with the preferred HBF type, a second HBF type, an HBF precoder associated with the second HBF type, or an effective rank associated with a second HBF type. The second configuration may be based on HBF information. For example, the second configuration may be based on HBF information related to a preferred HBF type of a plurality of HBF types and associated parameters.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram illustrating an example of a Channel State Information (CSI) measurement setting.

FIG. 3 is a diagram illustrating an example codebook-based precoding with feedback information.

FIG. 4 is a table showing an example of a codebook for 2Tx.

FIG. 5 is a block diagram illustrating an example of a hybrid beamforming architecture.

FIG. 6 is a chart illustrating examples of bit error rate (BER) performances for one or more hybrid beamforming approaches.

FIG. 7 is a chart illustrating examples of run times for one or more hybrid beamforming approaches.

FIG. 8 is a table showing examples of feedback overhead.

FIG. 9 is a diagram illustrating example hybrid beamforming (HBF) procedures for determining a preferred HBF type.

FIG. 10 is an example table illustrating table-based quantization, which may be used for one of the predefined quantization types.

FIG. 11 is a diagram illustrating formula-based quantization.

FIG. 12 is a table showing examples of formula-based relative quantization.

FIG. 13 is a diagram illustrating example procedures for an example adaptive Vandermonde-based codebook design.

### DETAILED DESCRIPTION

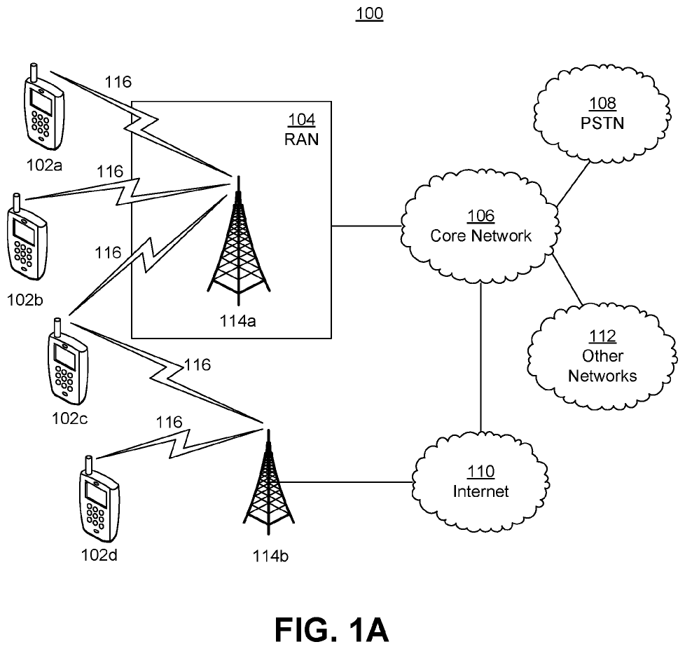

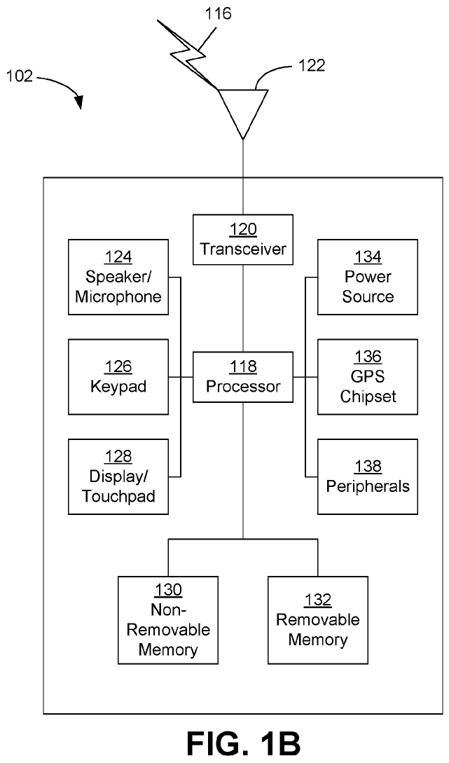

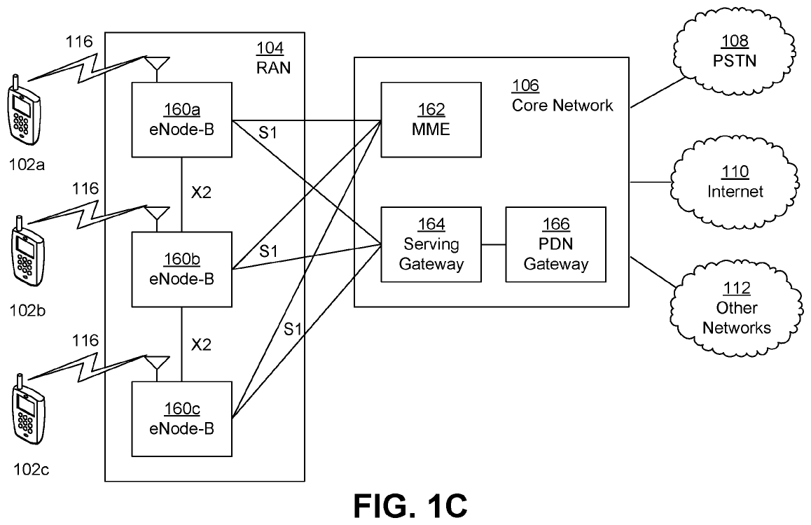

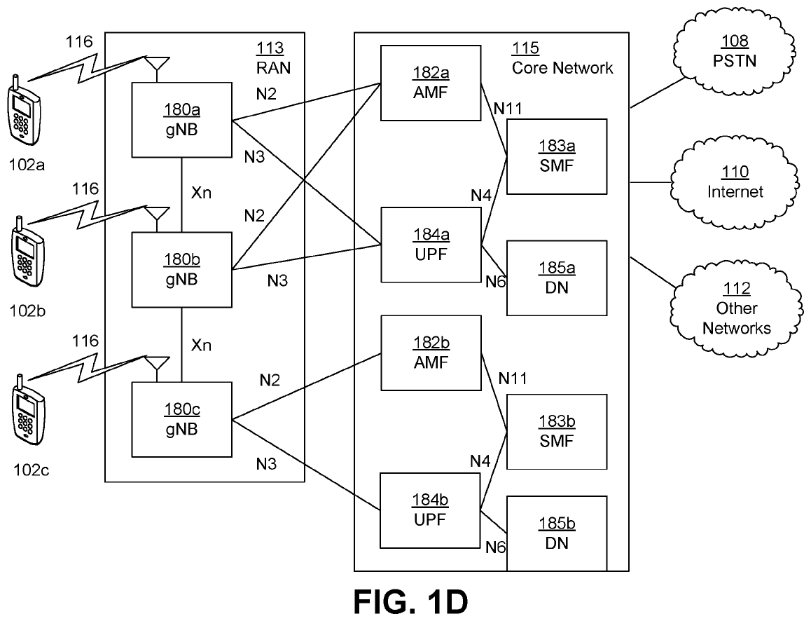

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHz, 8 MHZ, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b. 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network.

The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

When a base station (e.g., gNB) and a WTRU communicate, the devices may implement one or more beamforming procedures to focus wireless signals transmitted from a transmitter in a direction toward a receiver(s) or receiver antenna(s). Beamforming may be used to improve a signal to noise ratio, mitigate high propagation path loss, decrease interference, and/or focus signal transmissions to a desired location. As further described herein, the base station and/or the WTRU may include a number of transmit antennas at a transmitter and/or receive antennas at a receiver that may be implemented during a beamforming procedure to focus the signal transmissions. For example, the transmitter and/or receiver may include an antenna array or subarray. The transmitter may use multiple antennas of the array or subarray to send out and direct the same signal toward the receiver.

Analog beamforming involves variations in phase to a signal at a transmitter, which may use a single RF chain (e.g., including RF processing and ADC/DAC conversion) for an antenna array (e.g. a phase antenna array). Each antenna element may be connected to a phase shifter that may be used to set the weight for beam forming and beam steering. T.

Digital beamforming may have one RF chain (e.g., including RF processing and ADC/DAC conversion) for each antenna element of the antenna array. Thus, the signal at each antenna element may be controlled and/or processed independently in both phase and amplitude, for example to optimize system capacity.

Hybrid beamforming (HBF) may involve aspects of analog beamforming and/or digital beamforming. For example, a hybrid beamforming process may use antenna subarrays to transmit and/or receive signals. One or more data steams may be precoded (e.g., as in digital beamforming). The precoded data streams may be sent to analog beamformers (e.g., subarrays). Each subarray stream may be phase shifted to transmit a beam from each subarray. Each transmitted subarray beam may be directed to a receiver.

Millimeter wave (mmWave) systems may use (e.g., highly) directional systems to mitigate high path loss associated with higher frequency bands. Fully digital beamforming approaches may not be practical for large antenna array (e.g., transmit/receive element 122) systems, for example, due to increased power consumption associated with RF chains. To mitigate the power consumption, Hybrid Beamforming (HBF) architectures (e.g., which may use fewer RF chains than the number of antennas) may be used for mmWave multiple-input/multiple-out (MIMO) systems. In an example, HBF precoders may consist of digital precoders applied in the baseband, and/or analog beamformers applied at the RF. In an example, finding the analog beamformers (e.g., finding the optimal analog beamformers) may be a high latency and/or high overhead procedure (e.g., due to a large search space).

Systems and methods are described herein for HBF in wireless systems. When performing communications utilizing HBF, a gNB and a WTRU may utilize (e.g., different) HBF types. For example, HBF types may include one or more of U-unity magnitude, C-codebook based, and/or V-Vandermonde constrained HBF types. In some examples, beamforming solutions may use (e.g., either) predefined codebooks, and/or phase shifters (e.g., unit magnitude) for the analog beamforming weights. Codebook-based selection of the analog beamforming weights may, for example, tend to have low feedback overhead and/or may have suboptimal performance. Unit magnitude based analog beamforming may have better performance and/or may have increased feedback overhead. HBF precoders (e.g., for the Tx) and/or combiners (e.g., for the Rx) to reduce the feedback overhead (e.g., CSI) may be determined (e.g., while maintaining a target performance), for example for a HBF system. Analog precoders may be constrained to a Vandermonde structure, for example, to reduce the CSI feedback overhead. The WTRU may use methods to determine the preferred HBF type and/or report to the gNB.

A constraint may include one or more of payload size (e.g., allocated payload size), received signal to noise ratio (SNR), effective rank, one or more channel conditions, physical downlink shared channel (PDSCH) performance, and/or any (e.g., weighted) combination of these. Alternatively, or additionally, a constraint may include one or more of channel state information (CSI), block error rate (BLER) performance, (e.g., effective) resolution, reference signal received power (RSRP), delay spread, carrier frequency, modulation, subcarrier spacing, number of transmit and/or receive antennas, wavelength, an angle, an absolute angle, a relative angle, a central angle, a number of layers, precoding resource group (PRG) size, and WTRU speed.

A WTRU may perform procedures to determine one or more preferred HBF type and/or one or more HBF precoder. In one example, the WTRU may receive an indication and/or activation for enabling a HBF Type recommendation. For example, a higher layer parameter, HBF Type-Recommend, may be set to 1, which may indicate that the WTRU may determine and/or report the preferred HBF Type and/or the associated precoding weights. The WTRU may receive a configuration related to HBF processing, for example, a payload size (B) for reporting HBF-related information, a number of layers, precoding resource block group (PRG) size, HBF Type, effective rank, and/or the like. In another example, the WTRU may estimate a channel matrix, H[k]. The channel matrix, H[k] may be associated with the k-th sub-band, where k=1, . . . , K. In an example, the WTRU may derive analog and/or hybrid precoders associated with configured HBF Types (e.g., U-unity magnitude, C-codebook based, V-Vandermonde constrained, and/or the like). The WTRU may determine the preferred HBF Type based on a preconfigured and/or measured set of parameters (e.g., allocated payload size, received signal to noise ratio (SNR), effective rank, channel conditions, physical downlink shared channel (PDSCH) performance, and/or any weighted combination of these parameters and/or other like parameters). The WTRU may report (e.g., either implicitly or explicitly) the selected HBF Type and/or the associated hybrid precoders (e.g., F_{RF}, F_{BB}) and/or the effective rank associated with different HBF types.

A WTRU may perform procedures for adaptive Vandermonde-based codebook design. The WTRU may receive one or more configurations related to HBF Type V processing including, for example, relative angle, required resolution, quantization method, payload size for reporting Type V weights, and/or the like. The WTRU may estimate the channel matrix H[k] associated with the k-th sub-band, where k=1, . . . , K. The WTRU may derive analog and/or hybrid precoders associated with HBF Type V.

The WTRU may determine a set of Vandermonde phases, for example based on the allocated payload size. In an example, the WTRU may obtain a subset of phases by determining the central and/or relative angles based on channel measurements (e.g., Doppler, coherence time, and/or the like). In another example, the WTRU may obtain the set of phases based on one or more angle of arrival (AoA) measurements, one or more positioning related measurements (e.g., PRS), and/or the like. The WTRU may report the absolute and/or relative angles associated with a particular quantization method (e.g., table, formula, and the like). For example, the WTRU may report the relative angles and/or the quantization step from preconfigured values. The WTRU may determine a preferred HBF from a plurality of Vandermonde types, for example based on one or more parameters and/or measurements. For example, the WTRU may determine a preferred HBF from a plurality of Vandermonde types based on measured angle(s).

Channel State Information (CSI) may include one or more of the following: channel quality index (CQI), rank indicator (RI), precoding matrix index (PMI), an L1 channel measurement (e.g., reference signal received power (RSRP) such as L1-RSRP, signal to interference and noise ratio (SINR), and/or the like), CSI-RS resource indicator (CRI), SS/PBCH block resource indicator (SSBRI), layer indicator (LI), and/or any other measurement quantity measured by the WTRU from the configured reference signals (e.g. CSI-RS, SS/PBCH block and/or any other reference signal). A WTRU may be configured to report the CSI, for example through the uplink control channel on PUCCH, and/or per a gNB request on an UL physical uplink shared channel (PUSCH) grant. In an example, (e.g., depending on the configuration) CSI-RS may cover the full bandwidth of a BandWidth Part (BWP) or just a fraction of the bandwidth. Within the CSI-RS bandwidth, CSI-RS may be configured in each PRB and/or every other PRB. CSI-RS resources may be configured as one or more of periodic, semi-persistent, or aperiodic, for example in the time domain. A semi-persistent CSI-RS may be similar to periodic CSI-RS, except, for example, that the resource may be (de)-activated by MAC control elements (CEs). The WTRU may report related measurements when the resource is activated. The WTRU may be triggered to report measured CSI-RS on PUSCH by request in a DCI, for example for Aperiodic CSI-RS. Periodic reports may be carried over the PUCCH. For example, semi-persistent reports may be carried (e.g., either) on PUCCH and/or PUSCH. In an example, reported CSI may be used by the scheduler when allocating optimal resource blocks, for example, based on one or more of the channel's time-frequency selectivity, determining precoding matrices, beams, transmission mode and/or selecting suitable MCSs. In an example, the reliability, accuracy, and/or timeliness of WTRU CSI reports may be critical to meeting URLLC service requirements.

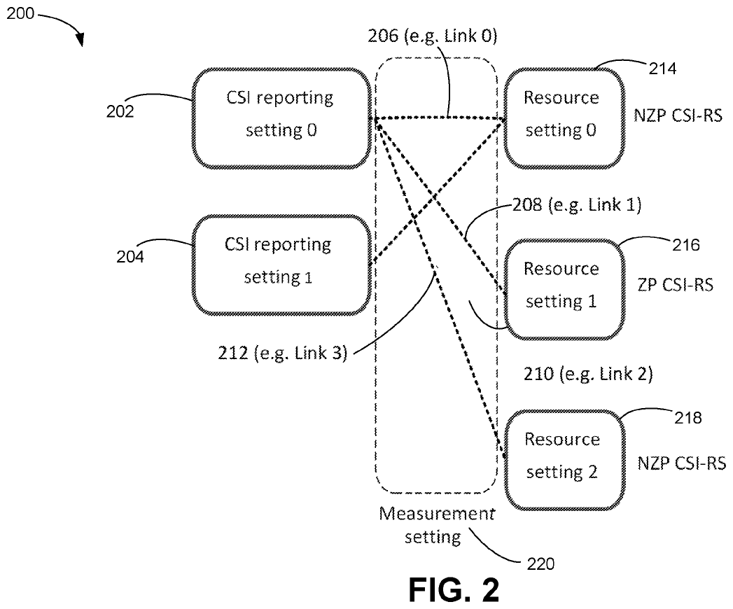

The WTRU may be configured with a CSI measurement setting. The CSI measurement setting may include one or more CSI reporting settings, resource settings, and/or a link between one or more CSI reporting settings and one or more resource settings. FIG. 2 shows an example system 200 of a configuration for CSI reporting settings 202, 204, resource settings 214, 216, 218, and links 206, 208, 210, 212. For example, there may multiple CSI reporting settings including, for example, CSI reporting setting 0 202 and/or CSI reporting setting 1 204. In a CSI measurement setting for example, one or more configuration parameters may be provided. An example configuration may include one or more of N≥1 CSI reporting settings 202, 204, M>1 resource settings 214, 216, 218, and a CSI measurement setting 220 which may link the N CSI reporting settings 202, 204 with the M resource settings 214, 216, 218. In some examples, there may be one or more of a link 206 (e.g., Link 0) between CSI reporting setting 0 202 and resource setting 0 214, a link 208 (e.g., Link 1) between CSI reporting setting 0 202 and resource setting 1 216, a link 210 (e.g., Link 2) between CSI reporting setting 0 202 and resource setting 2 218, and/or a link 212 (e.g., Link 3) between CSI reporting setting 1 204 and resource setting 0 214. For example, a CSI reporting setting may include one or more settings. A CSI setting may include time-domain behavior, which may be aperiodic and/or periodic/semi-persistent. A setting may include frequency-granularity, at least for PMI and/or CQI. A setting may include a CSI reporting type (e.g., PMI, CQI, RI, CRI, etc.). For example, a setting may include, if a PMI is reported, PMI Type (Type I or II) and/or codebook configuration. A resource setting may include one or more settings (e.g., multiple settings). A resource setting may include time-domain behavior, such as aperiodic and/or periodic/semi-persistent. For example, a resource setting may include RS type (e.g., for channel measurement or interference measurement). A resource setting may include S≥1 resource set(s) and/or each resource set may contain Ks resources. A CSI measurement setting 220 may include one or more settings (e.g., multiple settings). For example, a CSI measurement setting 220 may include one CSI reporting setting. In one example, a CSI measurement setting may include one resource setting. A CSI measurement setting 220 may include, for CQI, a reference transmission scheme setting. One or more frequency granularities may be supported for CSI reporting for a component carrier. A frequency granularity may be wideband CSI. For example, a frequency granularity may be partial band CSI. For example, a frequency granularity may be sub band CSI.

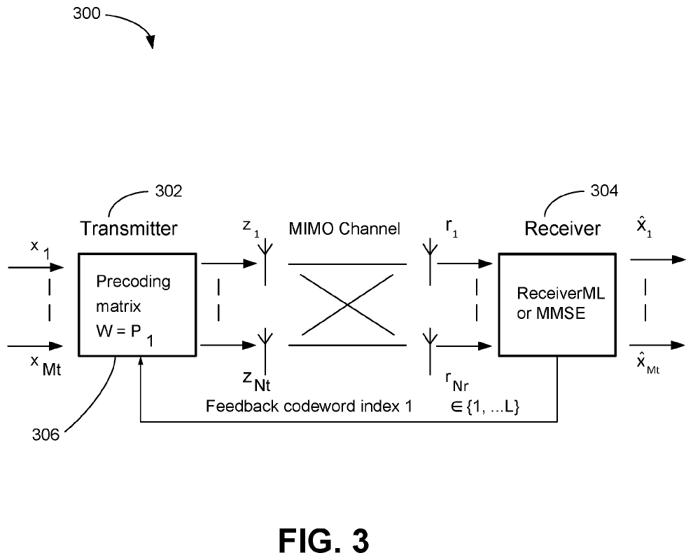

FIG. 3 illustrates an example system 300 of a basic concept of codebook-based precoding with feedback information. The system 300 may include a transmitter 302 capable of performing MIMO communications via multiple (e.g. Nt) transmit antennas. The transmitter 302 may transmit one or more streams (e.g., Mt data streams, or layers) x₁ to x_{Mt} of modulation symbols, where the number of streams Mt may be smaller than Nt. The symbols x₁ to x_{Mt} of the Mt streams may be generated by the baseband data channel processing and/or may be applied at the input of the precoder, for being transmitted via the Nt transmit antennas. The signals transmitted by the Nt transmit antennas are denoted by z1 to z_{Nt}. The system 300 may include a receiver 304 capable of receiving MIMO communications via multiple (e.g. Nr) receive antennas. The signals received at the antenna inputs are denoted with r₁ to r_{Nr}. The receiver 304 may process the signals received at the Nr antennas to recover the transmitted streams (e.g., data streams) \hat{x}₁ to \hat{x}_{Mt} for further (e.g. baseband) processing at the receiving device, where the number of transmitted streams Mt may be smaller than or equal to Nr.

For a closed loop MIMO system, the receiver 304 may provide channel state feedback information 306 to the transmitter 302; for example for codebook-based precoding. Feedback may consist of the index of the preferred codeword identified by the receiver (e.g., a codeword that maximizes the received signal to noise ratio). A codebook may include a set of vectors and/or matrices that, for example may help maximize the orthogonality of the composite channel matrix, in order to support multi-stream and/or multi-layer communications. The size of the vectors and/or matrices in the codebook may depend on the number of layers for the transmission and/or the number of transmit antenna ports. For example, for 1-layer transmission with two Tx antenna ports, the precoding codebook may include two-dimensional vectors of length 2, while for 2-layer transmission with two Tx antenna ports, the precoding codebook may include matrices of size 2x2. In another example, the structure of the codebook may be independent of the number of layers. For a transmitter equipped with Tx antenna ports, the precoding codebook may include two-dimensional vectors, for example where the number of selected vectors is equal to the number of layers. For example, one vector may be selected for 1-layer transmission while two vectors are selected for 2-layer transmission. The receiver 304 may implement detection or estimation algorithms, such as a maximum likelihood (ML) estimation algorithm or a minimum mean squared error (MMSE) estimation algorithm to generate feedback information 306 for being reported back to the transmitter 302. For example, the receiver 304 may implement the algorithms to estimate a channel response matrix and/or equalization algorithms. In another example, the receiver 304 may implement the algorithms to derive the fully digital beamformers, which for example may be used to generate hybrid beamforming feedback information 306.

The feedback information 306 may include a precoding matrix index (PMI). The PMI may be referred to as a codeword index, for example in the codebook as shown in the figure. As shown in FIG. 3, a codebook may include a set of precoding vectors/matrices for each rank and/or a number of antenna ports. Each precoding vectors/matrices may have its own index, for example so that a receiver 304 may inform preferred precoding vector/matrix index to a transmitter 302. The codebook-based precoding may have performance degradation, for example due to its finite number of precoding vector/matrix as compared with non-codebook-based precoding. In some examples, an advantage of a codebook-based precoding may be lower control signaling/feedback overhead.

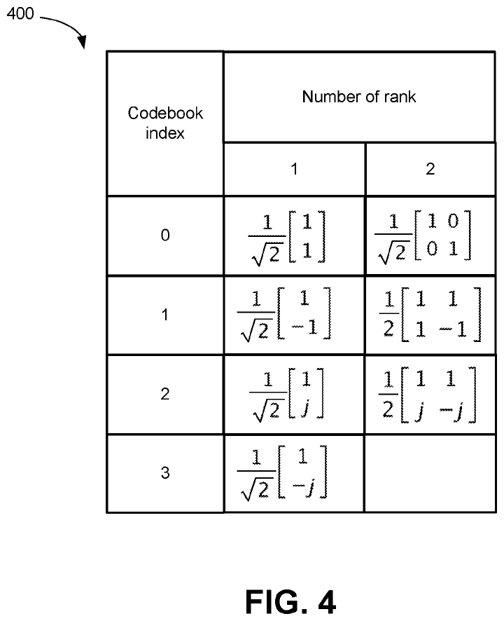

FIG. 4 shows a table 400 that illustrates an example of codebook for 2Tx antennas. For example, mmWave systems may use highly directional systems. Highly directional systems may mitigate a high path loss associated with higher frequency bands. Fully digital beamforming approaches that employ an RF chain for each antenna may not be practical for large antenna array systems, for example, due to the increased power consumption associated to the RF chains. In one example, transceiver architectures which use fewer RF chains than the number of antennas, which may be referred to as hybrid beamforming (HBF), may be used for mmWave MIMO systems. Additionally, or alternatively, transceiver architectures which use fewer RF chains than the number of antennas may mitigate the power consumption issue, for example while providing the beamforming gain to mitigate the path loss.

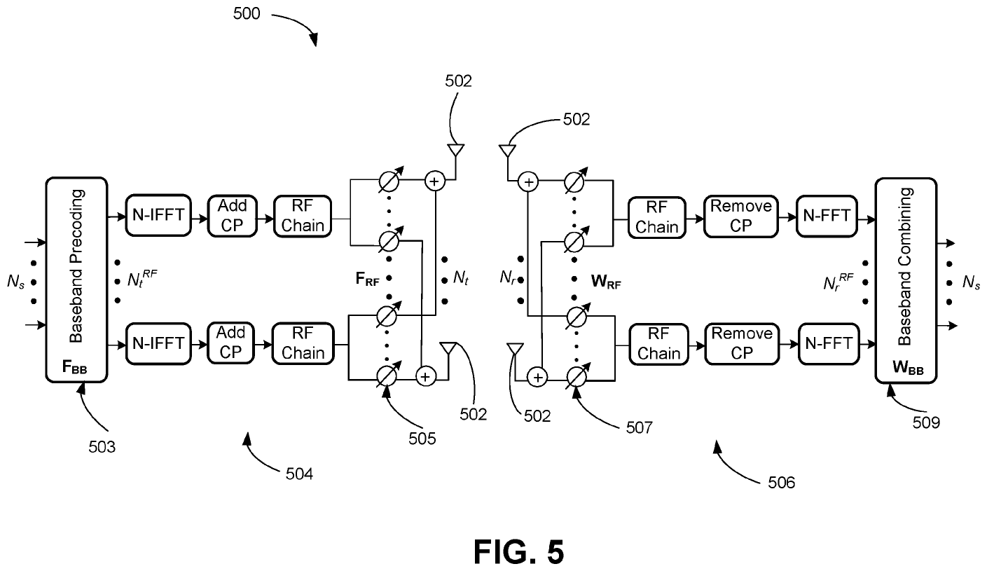

FIG. 5 shows a block diagram of an example system 500 of a fully connected hybrid beamforming architecture. As shown in the system 500, each RF chain may connect to each antenna element 502. The HBF precoders used at the transmitter 504 may include digital F_{BB} precoders 503 (e.g., which may be applied at the baseband) and/or analog F_{RF} beamformers 505 (e.g., which may be applied at the RF). The analog F_{RF} 505 may be selected from a pre-defined codebook (e.g., which may be codebook based HBF) and/or may use phase shifters (e.g., which may be unity magnitude based HBF). In an example, the HBF combiners used at the receiver 506 may include analog W_{RF} combiners 507 (e.g., which may be analog beamformers) and/or digital W_{BB} combiners 509. The full channel frequency response (CFR) matrix may be used, for example to determine the hybrid precoding and combining weights. In an example, the feedback overhead associated with reporting the estimated channel response matrix to the gNB (BS) may be large. For example, feedback overhead associated with reporting the estimated channel response matrix to the gNB (BS) may be large for multi-carrier massive MIMO systems.

The size of the full channel response matrix may be Nr×Nt×Nc, where Nr is the number of receive antennas, Nt is the number of transmit antennas, and Nc is the number of frequency-domain samples the CFR would be reported. In an example, when reported at sub-band resolution (e.g., 2 RB per sub-band), there may be 26 frequency-domain samples to be reported. For a system with 64 Tx antennas and 8 Rx antennas, the size of the full channel response matrix may be 8×64×26 complex numbers. This may quickly scale up as the number of Tx or Rx antennas increases, and/or as the bandwidth increases. The frequency of reporting the CSI feedback may contribute to the overhead.

Herein, Nₜ may represent the number of transmit antennas. Nᵣ may represent the number of receive antennas. Nₛ may represent the number of streams (e.g., the number of data streams Nₛ). The number of streams and the number of layers N_{L} may be used interchangeably herein. Nₜ^{RF} may represent the number of transmit RF chains. Nᵣ^{RF} may represent the number of receive RF chains. K may represent the number of sub-bands. H[k] (e. g., Nᵣ×) may represent a complex channel matrix, for example associated with sub-band k. F_{RF} (e.g., Nₜ×Nₜ^{RF}) may represent a complex analog precoder. F_{BB}[k] (e. g., Nₜ^{RF}×Nₛ) may represent the complex baseband (e.g., digital) precoder associated with sub-band k. W_{RF} (e.g., Nᵣ×Nᵣ^{RF}) may represent the complex analog combiner. W_{BB}[k] (e.g., Nᵣ^{RF}×Nₛ) may represent the complex baseband (e.g., digital) combiner associated with sub-band k. Fₒₚₜ[k] (e. g., Nₜ×Nₛ) may represent the complex optimal precoder associated with sub-band k. Wₒₚₜ[k] (e.g., Nᵣ×Nₛ) may represent the complex optimal combiner associated with sub-band k.

Beamforming solutions may use predefined codebooks and/or phase shifters (e.g., unit magnitude), for example for analog beamforming weights. In an example, codebook-based selection of the analog beamforming weights may have low feedback overhead and/or may have suboptimal performance. In another example, unit magnitude based analog beamforming may have higher performance than codebook-based selection of the analog beamforming weights and/or may have increased feedback overhead.

Embodiments herein may address the issue of determining the HBF precoders and/or the HBF combiners for an HBF system. For example, the embodiments may address how to determine the HBF precoders and/or the HBF combiners, for example to reduce the (CSI) feedback overhead while maintaining performance. The embodiments herein may address the issue of determining information relating to the HBF. For example, the embodiments may address how the WTRU may determine one or more preferred HBF types, and/or how a WTRU may reports the preferred HBF type(s) to the gNB. The embodiments herein may address the issue of designing analog precoders codebook to reduce overhead. For example, the embodiments may address how a WTRU may adaptively design analog precoders codebook to reduce overhead, while maintaining a target performance.

Hybrid beamforming may be posed as a factorization problem that may aim towards decomposing the fully digital SVD-based precoder Fₒₚₜ[k], for example to the hybrid precoding components F_{RF} and F_{BB}[k], for k∈[K]. In an example, the factorization may be solved under constraints which ensure that the analog precoder may be modeled using phase shifters. For example, the two widely-used feasibility sets may be unit modulus constraints (which may be herein referred to as HBF Type U and/or Type U) on the entries of each analog beamformer (e.g., [symbol] :={x∈ [symbol] | |x|=1}). Additionally or alternatively, the two widely-used feasibility sets may be, for example, codebook constraints (which may be herein referred to as HBF Type C and/or Type C), where for example, each analog precoder may belong to a predefined codebook known at the WTRU and/or gNB. In an example, the two feasible sets may yield an overhead-performance trade-off. In one example, a HBF Type U, may have greater link performance compared to Type C. In an example, the communication overhead of the HBF Type C may be considerably lower, which may, for example render HBF Type C more appropriate for limited feedback systems. Compared to Type C, the feedback overhead associated with Type U may scale linearly with the number of Tx/Rx antennas, which may, for example, preclude and/or limit the use of Type U in massive MIMO systems. As an example, the hybrid beamforming problem may be posed as in equation (1), where, for example, the feasible set [symbol] may be chosen according to either Type C or Type U.

$${min}_{{F}_{RF} , {\{ {F}_{BB} [ k ] \}}_{k = 1}^{K}} {\sum }_{k = 1}^{K} {‖ {F}_{opt} [ k ] - {F}_{RF} {F}_{BB} [ k ] ‖}_{F}^{2} \qquad ( 1 )$$

$$s . t . {F}_{RF} ∈$$

$${‖ {F}_{RF} {F}_{BB} [ k ] ‖}_{F}^{2} = {N}_{S} , ∀ k ∈ [ K ]$$

The WTRU may report its HBF capability, for example as a field under PHY parameters in WTRU radio access capability. The field may be denoted as HBF-PrecodingCapability, which may be, for example, one bit. The report of HBF capability (e.g., one bit) may indicate whether the WTRU may or may not support the hybrid precoders computation. In an embodiment, a WTRU may determine its capability based on one or more of: the number of free CPUs, an average computation time associated with one or more (e.g., each) type, a number of layers, a number of RF chains, a number of sub-bands, and/or the like. In an embodiment, a WTRU may be configured to report the hybrid precoders associated with a preconfigured HBF type. In an embodiment, a WTRU may be configured to directly report the optimal digital precoders associated with each sub-band. In an embodiment, a WTRU may be configured to report the CSI associated with the different sub-bands.

In an embodiment, a configuration (e.g., HBF-ReportConfig) may be associated with a single downlink BWP (e.g., which may be indicated by higher layer parameter BWP-Id). The configuration may contain one or more of: the HBF Type, a codebook configuration if the HBF Type is set to Type C, a number of sub-bands, quantization parameters if the HBF Type is set to Type U, other HBF related parameters (e.g., an effective rank indicator), a HBF wideband configuration which may contain parameters related to computing the analog precoders, and/or a HBF sub-band configuration for example with parameters related to the baseband parameters computation. The codebook configuration (e.g., CodebookConfig) may contain parameters for Type C, which may include, for example, a codebook subset restriction (e.g., when applicable).

A WTRU may be configured with the configuration (e.g., HBF-ReportConfig) set to none. In an example, a WTRU that is configured with HBF-ReportConfig set to ‘none’ may not derive and/or may not report any analog and/or digital precoder parameters. A WTRU may be configured to report SVD based digital precoders and/or the estimated CSI. If the WTRU is configured with HBF-ReportConfig with the HBF Type set to Type C then the WTRU may report a preferred analog precoder matrix for the configured codebook and/or the WTRU may report a preferred precoder (e.g., baseband) matrix per sub-band. In an example, if the WTRU is configured with HBF-ReportConfig with the HBFType set to Type U, then the WTRU may report a preferred analog precoder matrix (e.g., where each element may be of a unit modulus) and/or the WTRU may report a preferred precoder (e.g., baseband) matrix per sub-band. In a example, if the WTRU is configured with HBF-ReportConfig with the HBF-effRI set to 1, then the WTRU may report the effective rank associated with one, some, and/or all configured HBF Types.

High-quality HBF precoders with low feedback overhead may be determined. Analog beamformers may include a Vandermonde structure (e.g., herein referred to as HBF Type V). For example, to reduce the feedback associated with the analog beamformer (e. g., F_{RF}), while achieving a target performance, the analog beamformers may be constrained to have a Vandermonde structure (e.g., herein referred to as HBF Type V). The Vandermonde feasibility set may be defined as in equation (2), for example where ϕ∈−[π, π].

$$𝒱 = \{ x ∈ {ℂ}^{{N}_{t}} \vert x = {[ 1 , {e}^{j ϕ} , … , {e}^{j ( {N}_{t} - 1 ) ϕ} ]}^{T} \} \qquad ( 2 )$$

The hybrid beamforming problem with Vandermonde constraints may be expressed as in equation (3).

$${min}_{{F}_{RF} , {\{ {F}_{BB} [ k ] \}}_{k = 1}^{K}} {\sum }_{k = 1}^{K} {‖ {F}_{opt} [ k ] - {F}_{RF} {F}_{BB} [ k ] ‖}_{F}^{2} \qquad ( 3 )$$

$$subject to . {F}_{RF} ∈ 𝒱$$

$${‖ {F}_{RF} {F}_{BB} [ k ] ‖}_{F}^{2} = {N}_{S} , ∀ k ∈ [ K ]$$

Finding each analog beamformer may require computing a central angle ϕ, for example to generate an entire vector. In an example, from a feedback perspective, a WTRU may send back (e.g., transmit) to the gNB one angle for each analog precoder (e.g., regardless of the number of transmit antennas used). Such a constraint may yield a substantial decrease, for example a factor of Nₜ reduction, which may be significant in massive MIMO systems, in the feedback overhead. The decrease may be relative to using unit modulus constraints on entries of the analog beamformers. The feedback overhead of using unit modulus constraints on entries of the analog beamformers may scale up (e.g., increase) with the number of transmit antennas in some examples A tensor-based approach may be presented as an example for solving equation (3), for example with the introduced Vandermonde feasible set.

Analog precoders may be constrained to the Vandermonde structure. In an example, when analog precoders are constrained to the Vandermonde structure, problem (3) may be reformulated as a tensor problem that may, for example be solved using a tensor decomposition method. For example, assuming that the channel matrices {H[k]∈ [symbol] ^{N}^{ᵣ}^{×N}^{ₜ}}ₖ₌₁^{K} are estimated at the WTRU and the digital SVD-based precoders {Fₒₚₜ[k]∈ [symbol] ^{N}^{ₜ}^{×N}^{ₛ}}ₖ₌₁^{K} are derived, ∀k∈[K]. In an example, let the WTRU form the matrix X=[Fₒₚₜ[1], . . . , Fₒₚₜ[K]]∈ [symbol] ^{N}^{ₜ}^{×KN}^{ₛ}. Then, in the example, upon defining the matrix B=F_{BB}^{T}[1], . . . , F_{BB}^{T}[K]^{T}∈ [symbol] ^{KN}^{ₛ}^{×N}^{ₜ}^{^{RF}}, equation (3) may be expressed as equation (4), where (ϕ₀, . . . , ϕ_{N}_{ₜ}_{^{RF}}₋₁) are the Nₜ^{RF} angles which may be required to generate the Vandermonde-based precoders F_{RF}.

$$Find {F}_{RF} ( {ϕ}_{0} , … , {ϕ}_{{N}_{t}^{RF} - 1} ) , B \qquad ( 4 )$$

$$s . t . X \approx {F}_{RF} {B}^{T} , {F}_{RF} ∈ 𝒱$$

In an embodiment, the following two subarrays are constructed:

$$A = {F}_{RF} ( 1 : end - 1 , : ) , ( e . g . , all rows except last )$$

$$\overline{A} = {F}_{RF} ( 2 : end , : ) , ( e . g . , all rows except first )$$

Constructed (Nₜ−1)×Nₜ^{RF} subarrays A and Ā may be displaced and/or may otherwise be identical subarrays. For example, by exploiting the Vandermonde structure of the columns of the matrix F_{RF}, the constructed (Nₜ−1)×Nₜ^{RF} subarrays A and Ā may be displaced but may otherwise be identical subarrays. The relation Ā=AΦ₁ may hold, where, for example, Φ₁:=Diag([e^{-ϕ}^{₀}, . . . , e^{-ϕN}^{ₜ}^{^{RF}}⁻¹]).

In an example, let A=AΦ₀ where Φ₀=I_{N}_{ₜ}_{^{RF}}. If, for example, X₀=X(1:end−1,:)∈C^{(N}^{ₜ}^{-1)×KN}^{ₛ}, X₁=X(2:end,:)∈C^{(N}^{ₜ}^{-1)×KN}^{ₛ}, equation (5) may follow.

$${X}_{0} = {AD}_{0} ( C ) {B}^{T} \qquad ( 5 )$$

$${X}_{1} = {AD}_{1} ( C ) {B}^{T}$$

In equation (5) for example, Dₚ(C) may be a diagonal matrix holding the p-th row of C on its diagonal and/or C may be a matrix holding the diagonal of Φₚ on its p-th row, and p=1,2. The model in equation (5) may be a two-slab canonical polyadic decomposition (CPD) (e.g., which may be known as a parallel factor (PARAFAC) analysis), for example with a Vandermonde structure in one mode. A WTRU may use Type V, for example for deriving hybrid precoders. For example, to use Type V for deriving the hybrid precoders, the WTRU may form the two matrices X₀ and X₁, and/or concatenate them to construct the tensor [symbol] ∈ [symbol] ^{(N}^{ₜ}^{-1)×KN}^{ₛ}^{×2}. Then, for example, the WTRU may pass the constructed tensor to PARAFAC to obtain (ϕ₀, . . . , ϕ_{N}_{ₜ}_{^{RF}}₋₁) and/or the baseband precoders {F_{BB}[k]∈ [symbol] ^{N}^{ₜ}^{^{RF}}^{×N}^{ₛ}}ₖ₌₁^{K}.

In an example, to show the practical feasibility of the proposed tensor approach, the performance may be evaluated on a 3GPP link level channel model. The adopted simulation parameters may include one or more of the following. The CDL-C channel model, for example may be used with one or more of the delay spread set to 300 ns, carrier frequency may be set to 28 GHZ, 16-QAM modulation, subcarrier spacing may be set to 60 KHz, number of transmit and receive antennas may be set to 32 and 8, respectively, and WTRU speed may be set to 0.5 km/hr. In an example, a BS and/or a WTRU may be equipped with a uniform linear array where the antenna elements may be separated by a half wavelength. Results may be averaged out over a number of realizations (e.g., 200 realizations). The number of subbands may be set to 30, (e.g., K=30), where for example each subband may consist of one resource block (RB) (e.g., 12 subcarriers). The channel matrix for each subband may be obtained by averaging out the channels across the a number of subcarriers (e.g., 12 subcarriers). The TALS algorithm may be implemented, for example in the Tensorlab MATLAB toolbox.

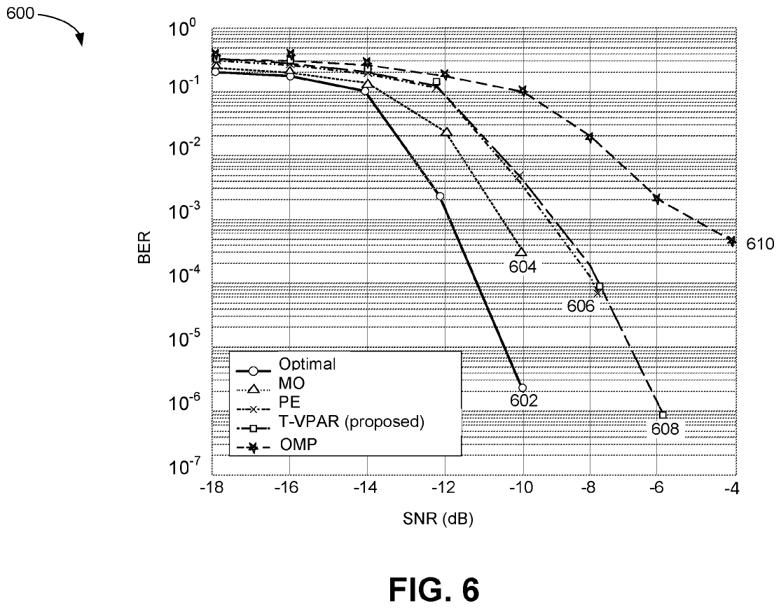

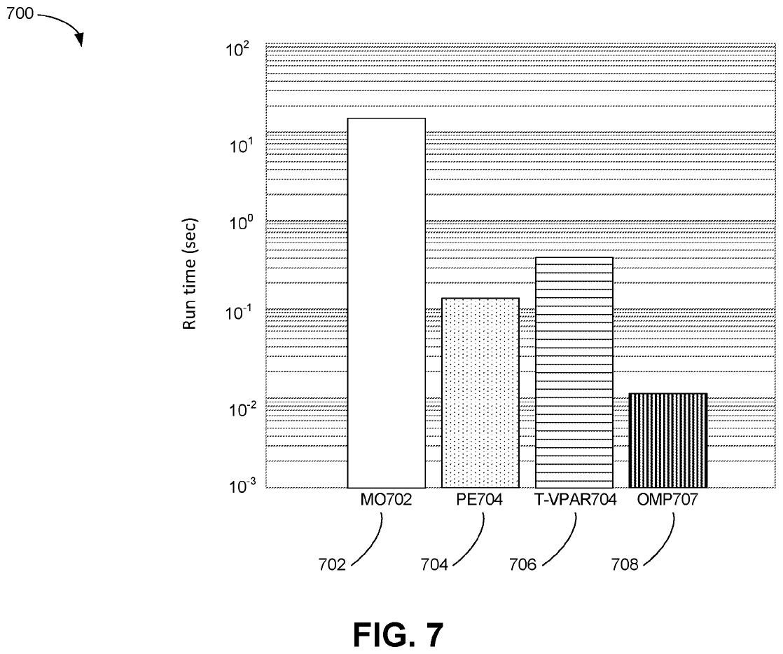

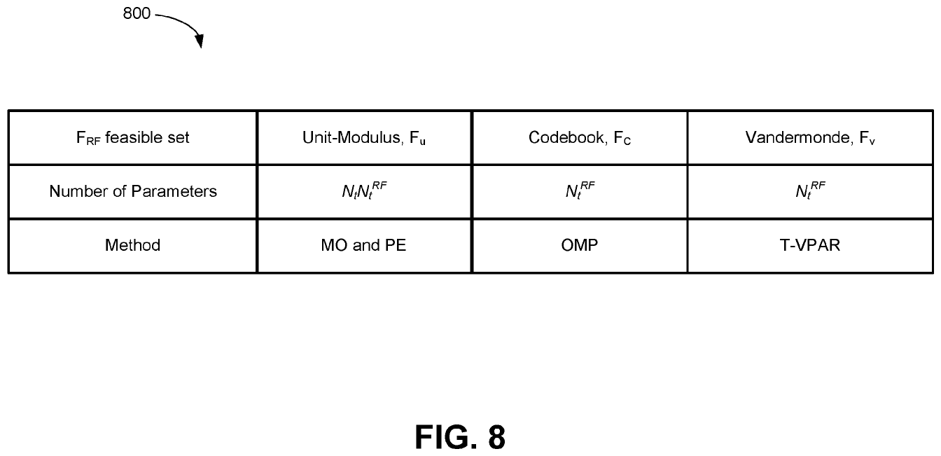

FIG. 6 is a chart 600 illustrating examples of bit error rate (BER) performances for a tensor approach. FIG. 7 is a chart 700 illustrating examples of run times for a tensor approach. The results shown in FIG. 6 and FIG. 7 may be for the case with Nₜ^{RF}=Nᵣ^{RF}=3 and Nₛ=2. In an example shown in FIG. 6, the embodiment (e.g., T-VPAR 606), for HBF Type V, may achieve greater performance than the orthogonal matching pursuit (OMP) method 610 (e.g., Type C) and/or may, for example, achieve comparable performance to the manifold optimization (MO) 604 and/or phase extraction (PE) 608 methods (e.g., Type U). The optimal method 602 may achieve greater performance than the others. In an example, as in FIG. 7, the embodiment (e.g., T-VPAR 706), for HBF Type V, may outperform the PE method 704 (e.g., Type U). Further, in terms of complexity, the proposed method, T-VPAR 706 (e.g., Type V), may come in-between OMP 708 (e.g., Type C) and MO 702 (e.g., Type U), as shown in FIG. 7. In an example, from the feedback overhead perspective, the OMP (e.g., Type C) and/or the proposed method (e.g., Type V) may achieve lower overhead compared to PE and/or MO (e.g., Type U), as shown in the table 800 of FIG. 8. This is because for the OMP and/or the proposed method, a single parameter may be reported per each Tx RF chain (e.g., for a total of Nₜ^{RF} feedback parameters). For the PE and/or MO methods, Nₜ parameters may be reported for each Tx RF chain (e.g., for a total of NₜNₜ^{RF} feedback parameters). In other words, OMP and/or the proposed method may result in an overhead reduction factor of Nₜ compared to PE and/or MO methods (e.g., Type U). For massive MIMO systems, the number of transmit antennas Nₜ may be on the order of hundreds (e.g., 200), which may result in Type V and/or Type C having orders of magnitude of reduction in overhead relative to Type U. A preferred HBF type may be determined via one or more methods for example. Different HBF types may have different characteristics that may include performance, overhead and/or complexity. For example, HBF Type U may yield higher performance when compared to one or more other types. HBF Type U may result in higher feedback overhead and/or higher complexity when compared to one or more other types. In an example, Type C may achieve a (e.g., relatively) low level of overhead (e.g., one feedback parameter per Tx RF antenna chain, compared to Nₜ feedback parameters per Tx RF antenna chain for HBF Type U methods). Additionally, or alternatively, Type C may achieve (e.g., relatively) low performance. Type V may achieve target performance. Type V may achieve (e.g., relatively) low overhead.

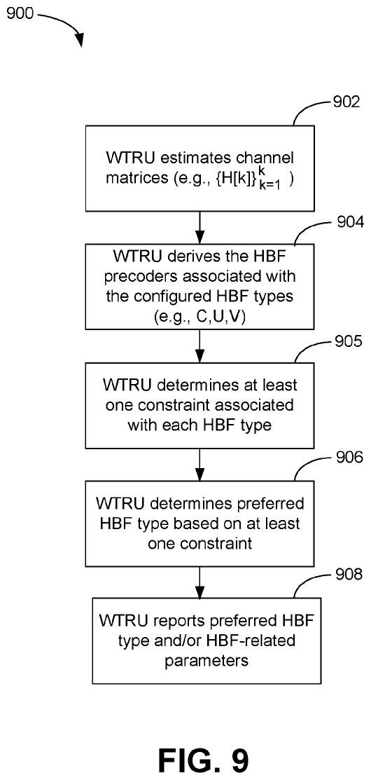

A WTRU may be configured to recommend and/or select a preferred HBF Type (e.g., using a higher layer parameter UErecommend-HBFType). In an example, if activated, a WTRU may determine and/or report a preferred HBF Type (e.g., C, U, and/or V) for computing hybrid precoders. FIG. 9 provides an example of high-level steps for determining and/or reporting a preferred HBF type. In some examples, a preferred HBF type may be determined based on PDSCH performance. The WTRU may select the HBF type based on PDSCH performance. For example, different types may yield different hybrid precoders, for example given the same channel input. Different types may result in different average block error rate (BLER) performance. The WTRU may switch between different types, for example based on the observed average BLER. For example, for given a target BLER (e. g., γₜₕ), the WTRU may derive the precoders of the HBF type with lower or minimum overhead (e.g., Type C) and/or compare the observed BLER with the target BLER. The WTRU may determine a preferred HBF Type (e.g., with higher resolution) that may improve the BLER. For example, if the observed BLER is greater than γₜₕ, the WTRU may determine a preferred HBF Type (e.g., with higher resolution) that may improve the BLER. The WTRU may switch to another HBF type with lower granularity (e.g., Type C or Type V). For example, if the selected HBF Type (e.g., Type U) results in a BLER that is lower than γₜₕ (e.g., by a defined threshold), the WTRU may switch to another HBF type with lower granularity (e.g., Type C or Type V). The WTRU may switch between different Types, for example using a mapping between the different Types and the target BLER. The WTRU may be configured with different BLER ranges. For example, the WTRU may be configured with a recommended type for each BLER range. In one example, when BLER>0.1, Type C may be recommended; when BLER is between 0.01 and 0.1, Type V may be recommended; and/or when BLER is <0.01, Type U may be recommended. The WTRU may indicate one or more criteria used in determining a preferred HBF type, for example by adding a field in physical layer parameters under WTRU radio access capability parameters. In one example, HBFTypeSelectPDSCH=1(0) may indicate that HBF type selection based on PDSCH performance may be activated.

One or more preferred HBF types may be determined based on uplink control information (UCI) allocation and/or physical uplink control channel (PUCCH) resource configuration. A WTRU may select and/or recommend a HBF Type, for example based on the number of available UCI bits for HBF reporting. The number of available UCI bits may be limited by one or more of gNB allocation, other co-scheduled CSI reports, acknowledgement/negative acknowledgement (ACK/NACK) reporting, and/or the like. For example, the WTRU may determine the HBF Type based on the available resources in the UCI allocation. Different types may be associated with minimum required resolution levels. For example, Type V may have different resolution levels and/or may result in different allocations. The WTRU may determine that the available UCI is not sufficient to find HBF Type and/or use one configured HBF type (e.g., Type V) with the requested resolution. The WTRU may select and/or recommend the HBF Type based on the allocated payload size for HBF reporting. Different types may have different resolutions. For example, types with feedback overhead with a number of bits less than or equal to the payload size may be considered. In some examples, types with feedback overhead with a number of bits less than or equal to the payload size may be considered. The WTRU may determine which types result in feedback overhead less than or equal to the number of PUCCH payload bits (B). The WTRU may select one or more of the types satisfying the payload size constraint. For example, the WTRU may select one or more HBF types yielding overhead Bᵢ≤B.

FIG. 9 illustrates an example HBF procedure 900 for determining a preferred HBF type. One or more portions of the procedure 900 may be performed at a WTRU. At 902, the WTRU may estimate a channel matrix, H[k]. The channel matrix H[k] may be estimated using one or more estimation algorithms, such as a maximum likelihood (ML) estimation algorithm or a minimum mean squared error (MMSE) estimation algorithm. The channel matrix, H[k] may be associated with the k-th sub-band, where k=1, . . . , K. The WTRU may be configured to receive a configuration related to HBF processing. Alternatively, or additionally, the WTRU may be configured to derive the configuration related to HBF processing, for example based on one or more measurements made by the WTRU. The configuration may include a first configuration. The WTRU may be configured to receive and/or derive a second configuration related to a hybrid beamforming (HBF) processing.

At 904, the WTRU may derive analog and/or hybrid precoders associated with configured HBF Types (e.g., U-unity magnitude, C-codebook based, V-Vandermonde constrained, and/or the like). For example, the WTRU may derive the analog and/or hybrid precoders for each configured HBF type capable of being utilized at the WTRU and/or NB. The WTRU may derive one or more HBF precoders using the channel matrix.

At 905, the WTRU may determine at least one constraint associated with each HBF Type. The at least one constraint may be related to processing performance and/or feedback overhead. For example, a constraint may include one or more of payload size (e.g., allocated payload size), t, received signal to noise ratio (SNR), effective rank, one or more channel conditions, physical downlink shared channel (PDSCH) performance, and/or any (e.g., weighted) combination thereof. Alternatively, or additionally, a constraint may include one or more of channel state information (CSI), block error rate (BLER) performance, (e.g., effective) resolution, reference signal received power (RSRP), delay spread, carrier frequency, modulation, subcarrier spacing, number of transmit and/or receive antennas, wavelength, an angle, a delta angle, an absolute angle, a relative angle, a central angle, a number of layers, precoding resource group (PRG) size, and/or WTRU speed. The HBF precoders may be associated with at least one constraint related to processing performance or feedback overhead.

At 906, the WTRU may determine the preferred HBF Type. For example, the preferred HBF Type may be determined based on a preconfigured and/or measured set of parameters. The preconfigured and/or measured set of parameters may be associated with the configuration related to HBF processing. The preferred HBF Type may be determined based on the at least one network constraint associated with each HBF Type and/or the measured set of parameters, for example Vandermonde may be selected when feedback size is limited and the measured performance meets the configured target performance. One of the HBF types may include a Vandermonde structure. The WTRU may determine a preferred HBF from one or more of the same HBF type. For example, the WTRU may determine a preferred HBF from a plurality of Vandermonde types. The WTRU may determine the preferred HBF based on the one or more parameters, constraints, and/or measurements.

The WTRU may switch between HBF types. For example, based on a second configuration related to the HBF processing and/or at least one constraint related to processing performance or feedback overhead associated with each of the plurality of HBF types, the WTRU may switch from the first preferred HBF type to a second preferred HBF type of a plurality of HBF types. Switching from the first preferred HBF type to a second preferred HBF type of the plurality of HBF types may be based on a trigger event. The trigger event may include satisfying one or more of a performance threshold value, a threshold associated with a monitored value, and a preconfigured condition. Additionally, or alternatively, switching or selecting an HBF type may be at least partially based on an angle, for example as described herein.

At 908, the WTRU may report (e.g., either implicitly and/or explicitly) the selected HBF Type and/or HBF-related parameters. The HBF-related parameters may include the associated hybrid precoders (e.g., F_{RF}, F_{BB}) and/or the effective rank or effective rank indicator.

The WTRU may report to a base station HBF information related to the preferred HBF type of the plurality of HBF types and associated parameters based on a configuration related to HBF processing and/or at least one constraint related to processing performance or feedback overhead associated with each of the plurality of HBF types. The HBF information may indicate at least one of the preferred HBF Type, an HBF precoder associated with the preferred HBF type, or an effective rank associated with the preferred HBF type. The WTRU may report to the base station second HBF information related to the second preferred HBF type of the plurality of HBF types and associated parameters. The second HBF information may indicate at least one of the second preferred HBF Type, an HBF precoder associated with the second preferred HBF type, or an effective rank associated with the second preferred HBF type. Reporting to the base station may include reporting a Vandermonde based codebook derived from one or more measurements made by the WTRU.

The WTRU may receive one or more configurations. The one or more configurations may be received from a base station. After an initial configuration is received from a base station that indicates a HBF type and/or other HBF information, the WTRU may receive one or more updated configurations. For example, in response to the preferred HBF type and/or HBF information, the WTRU may receive a configuration that includes information related to the preferred HBF type or to another HBF type. For example, the configuration may include an acknowledgement of the preferred HBF type. The configuration may alternatively, or additionally, include one or more other HBF types. The configuration may include an acknowledgement of a precoder associated with the preferred HBF type. Additionally, or alternatively, the configuration may include one or more other HBF precoders. The configuration may include an acknowledgement of the effective rank associated with the preferred HBF type. In some examples, the configuration may include information associated with one or more of the preferred HBF type, another HBF type, the HBF precoder associated with the preferred HBF type, an HBF precoder associated with another HBF type. Additionally, or alternatively, the configuration may include the preferred HBF type and/or the HBF precoder associated with the HBF type selected from the effective rank associated with the preferred HBF type. Alternatively, or additionally, the configuration may include another HBF type and/or another HBF precoder associated with the HBF type selected from the effective rank associated with the preferred HBF type.

The WTRU may perform HBF processing based on the configuration. The HBF processing may include a determination based on one or more constraint, parameter, and/or feedback overhead. The WTRU may utilize the configuration for one or more subsequent communications. The WTRU may switch from one HBF type to another HBF type, for example based on the configuration and/or one or more constraint, parameter, and/or feedback overhead. HBF information may be reported, for example to a base station. The HBF information may be related to a preferred HBF type. Additionally, or alternatively, the WTRU may send one or more constraint, parameter, and/or feedback overhead to a base station. The HBF information may indicate one or more of the preferred HBF Type, another HBF type, the HBF precoder associated with the preferred HBF type, a precoder associated with another HBF type, the effective rank associated with the preferred HBF type, and an effective rank associated with another HBF type.

In some examples, one or more preferred HBF types may be determined and/or reported based on one or more WTRU measurements. The WTRU may select and/or recommend the HBF Type based on a combination of different measurements, for example if the higher layer parameter UErecommend-HBFTypeSelection is activated. The WTRU may select and/or recommend the HBF Type based on one or more (e.g., a combination of different) measurements comprising: CSI related measurements, rank measurements, the number of layers (N_{L}), available computation resources (e.g., number of free CPUs), received SNR, number of subbands, and/or the like. In an example, the WTRU may compute the rank (e.g., Rₑ⁽ⁱ⁾) of the effective channel H_{eff}⁽ⁱ⁾∈ [symbol] ^{N}^{_{RF}}^{×N}^{_{RF}} associated with Types U, C, V. For example, the effective channel may be defined as in equation (6).

$${H}_{eff}^{( i )} [ k ] = {W}_{RF}^{* ( i )} H [ k ] {F}_{RF}^{( i )} \qquad ( 6 )$$

where W_{RF}^{*(i)} and F_{RF}⁽ⁱ⁾ are the analog precoders and combiners derived based on Type i, and H[k]∈ [symbol] ^{N}^{ᵣ}^{×N}^{ₜ} is the estimated channel matrix at subband k, for k=1, . . . , K, and i may be U, V, C. The effective channel may incorporate an effect of analog beamforming, for example on one or more of (e.g., both) the transmit side and the receive side. The WTRU may compute the effective rank (e.g., which may be the rank of the effective channel) as in equation (7).

$${R}_{e}^{( i )} = {min}_{k} \{ rank ( {H}_{eff}^{( i )} [ k ] ) \} \qquad ( 7 )$$

The WTRU may select and/or recommend a HBF Type as a function (e. g., of N_{L}, N_{RF}, Rₑ⁽ⁱ⁾). For example, the WTRU may choose between the HBF types that yield an effective rank greater than the configured number of layers. The WTRU may report one or more effective ranks associated with one or more (e.g., different) HBF types. The WTRU may select and/or recommend a HBF Type based on a received SNR. In an example, different types may behave differently at one or more (e.g., various) SNR levels. The WTRU may recommend and/or select one or more HBF types, for example based on one or more measured SNRs. For example, Type V may yield greater performance compared to Type U at the low SNR region and/or Type U may yield greater performance at the high SNR. The WTRU may select and/or recommend a HBF Type based on a number of subbands. In an example, the number of digital precoders may be dependent on the number of configured subbands. In an example, the complexity of finding the digital (e.g., baseband) precoders may scale with the number of subbands. In an example, different types may require different computations as the number of subbands increases. The WTRU may recommend and/or select the HBF type based on one or more of the allocated bandwidth part, the subband size and/or the WTRU HBF computational capability (e.g., the number of available CPU resources). In an example, the WTRU may select and/or recommend one or more HBF types based on one or more (e.g., different) measured quantities, for example with different weight for each quantity. The WTRU may reconstruct a feature vector comprising different parameters. For example, the feature vector may be formed as x= [SNR,BLER,eff.rank,numberofbits,channelquality,K,subcarrierspacing]. The WTRU may select and/or recommend a HBF type, for example based on a function ƒ(x). The function ƒ(x) may take the feature vector as an input and/or may yield one of the configured types.

A WTRU may be configured with one or more triggers, for example for a WTRU to report a preferred HBF type or provide an HBF type recommendation. For example, the one or more triggers may cause the procedure 900, or one or more portions thereof, to be initiated. The one or more triggers may enable the selection and/or reporting of the preferred HBF type and/or related parameters (e.g., effective rank), for example from a set of configured HBF types. In some examples, the WTRU may be triggered to report the preferred HBF type based on one of a time based trigger and an event based trigger. For example, a time based trigger may include aperiodic, periodic, and/or semipersistent reporting of the HBF Type recommendation and/or related parameters (e.g., effective rank). In another time based trigger example, the WTRU may recommend the preferred HBF type based on a preconfigured report periodicity. In other time based trigger examples, the WTRU may perform aperiodic reporting of preferred HBF type upon decoding a specific DCI format that triggers an aperiodic HBF type recommendation trigger state. In yet another time based trigger example, the WTRU may recommend the preferred HBF type in a semi-persistent mode over the data channel (e.g., PUSCH). An event based trigger may include the WTRU reporting the preferred HBF type based on a monitored metric, for example exceeding a preconfigured threshold or condition. In one example, the event based trigger may be when a (e.g., measured) number of consecutive NACKs exceeds a certain preconfigured number. In another event based trigger example, the WTRU may report the preferred HBF type based on a relationship between the measured rank (e.g., channel rank) and the measured effective rank (e.g., rank of the effective channel, for example including the analog precoders and combiners). For example, the WTRU may report the preferred HBF type when the measured rank is greater than the measured effective rank.

A WTRU may be configured with one or more triggers, for example for HBF type switching. For example, the WTRU may be configured with a performance threshold value for HBF type switching. The WTRU may receive the configuration via radio resource control (RRC) signaling. In another example, the WTRU may be triggered to switch the HBF type based on a preconfigured/predefined performance threshold value. For example, the threshold value may represent the normalized mean squared error (NMSE) between the digital precoder Fₒₚₜ and the hybrid precoders F_{RF}F_{BB}, for example associated with the different HBF types (e.g., U, C, V). The WTRU may switch to the HBF type with a minimal error that satisfies the configured threshold. In another example, the WTRU may switch to the HBF type that satisfies the configured threshold and/or has the minimum feedback overhead.

Precoders may be determined, for example under codebook constraints. An overall optimization with a codebook constraint on the analog precoders, (e.g., such that the columns of F_{RF} are taken from the codebook C), may be reformulated as in equation (8)

$${min}_{{F}_{RF} , {\{ {\tilde{F}}_{BB} [ k ] \}}_{k = 1}^{K}} {\sum }_{k = 1}^{K} {‖ {F}_{opt} [ k ] - C {\tilde{F}}_{BB} [ k ] ‖}_{F}^{2} \qquad ( 8 )$$

$$s . t . {{\tilde{F}}_{BB} [ k ]}_{i , :} = 0. ∀ i ∈ S , \vert S \vert = {N}_{t} - {N}_{t}^{RF}$$

where F_{RF} may be replaced by the codebook C, and/or the matrix Nₜ^{RF}×Nₛ matrix F_{BB}[k] may be replaced with Nₜ×Nₛ matrix \tilde{F}_{BB}[k]. Sparsity constraints may be imposed, for example on \tilde{F}_{BB}[k] to ensure, only Nₜ^{RF} rows may be non-zero and the rest may be zero. In an example, the sparsity constraint may ensure that only NRF columns of the codebook may be selected. For example, the set S may contain Nₜ−Nₜ^{RF} distinct entries in the range {1, . . . , Nₜ}, and/or may indicate the indices of the all-zero rows of \tilde{F}_{BB}[k]. The DFT codebooks may be used in the 3GPP standard, for example if the codebook is orthogonal. The optimization may be as in, for example, equation (9).

$${min}_{{F}_{RF} , {\{ {F}_{BB} [ k ] \}}_{k = 1}^{K}} {\sum }_{k = 1}^{K} {‖ {C}^{H} {F}_{opt} [ k ] - {\tilde{F}}_{BB} [ k ] ‖}_{F}^{2} \qquad ( 9 )$$

$$s . t . {{\tilde{F}}_{BB} [ k ]}_{i , :} = 0. ∀ i ∈ S , \vert S \vert = {N}_{t} - {N}_{t}^{RF}$$

This problem (e.g., equation (9)) may be (e.g., efficiently) solved and/or may have a globally optimal solution. The optimal F_{RF} and F_{BB}[k] may be represented as given as in equation (10).

$${{F}_{BB} [ k ]}_{i , :} = {C}^{H} {{F}_{opt} [ k ]}_{j , :} . \vert j = {Z}_{i} , i ∈ \{ 1 , … , {N}_{t}^{RF} \} \qquad ( 10 )$$

$${F}_{RF i , :} = {C}_{: , j} \vert j = {Z}_{i} , i ∈ \{ 1 , … , {N}_{t}^{RF} \}$$

$$Z ∈ arg sort \{ ( {\sum }_{k} {‖ {C}^{H} {{F}_{opt} [ k ]}_{1 , :} ‖}_{2}^{2} ) , … , ( {\sum }_{k} {‖ {C}^{H} {{F}_{opt} [ k ]}_{{n}_{t} , :} ‖}_{2}^{2} ) \}$$

For example to incorporate the power constraint, ∥F_{RF}F_{BB}[k]∥_{F}²=Nₛ, an additional normalization of the form, F_{BB}[k]=\sqrt{Nₛ}F_{BB}[K]/∥F_{RF}F_{BB}[k]∥_{F}² may be used.

One or more preferred HBF type and/or HBF precoders may be reported. For example, a WTRU may (e.g., be able to) support more than one type of HBF weight reporting (e.g., HBF Type U, HBF Type C, HBF Type V, and/or the like). The WTRU may indicate the supported HBF weight reporting types, for example in the WTRU Capability Information. The WTRU supporting HBF may report analog and/or digital precoder values (F_{RF}, F_{BB}), for example to the gNB. The WTRU supporting HBF may report both analog and digital precoder values (F_{RF}, F_{BB}) to the gNB. The analog precoder values may apply to the entire channel. The digital precoders may apply to one or more of individual sub-carriers, sub-bands, resource elements, and resource blocks. In some examples, the granularity of the analog precoding reporting may be configured by the gNB. The reporting configuration may be configured in a semi-static fashion using RRC signalling. In an example, the WTRU CSI Report may include (e.g., both) the analog and/or the digital precoder weights in a single report. In an example, the WTRU CSI Report may include both the analog and digital precoder weights in one or multiple reports. In an example, a report may include an effective rank indicator. The effective rank indicator may be used to (e.g., be associated with) determine the maximum number of layers, for example that may be sent in the next slot. The size of the report may vary, for example depending on the chosen reporting type. Alternatively, or additionally, the WTRU may split the information into multiple (e.g., two) parts. A first part may contain the effective channel rank indicator. A second part may contain the weights determined using the configured type. In an example, the WTRU may split the reporting of the analog and digital weights in two or more reports. In an example, the WTRU may be configured (e.g., by the gNB) to use one of the available forms of CSI reporting. In an example, this configuration may occur as one or more of part of the control channel signaling, RRC signaling and/or via MAC-CE indication. The WTRU may be configured to use a specific CSI reporting type, for example at a particular time. The WTRU may be configured with a time when it may need to switch from a particular CSI reporting configuration (e.g., report splitting, estimation technique, and/or the like) to a new configuration. Alternatively. or additionally, the WTRU may not receive an explicit time delay for starting and/or switching to a particular reporting configuration. The WTRU may use a default configuration which, for example may have been previously configured.

The indication of HBF type and/or precoders may be implicit. The WTRU may be configured to utilize one or more of (e.g., either) the constant modulus method and the Vandermonde-based method, for example to determine the HBF weights. A gNB may configure the WTRU. The size of the reports corresponding to the two types may be different, for example due to the different amounts of feedback generated for the two types. The WTRU may be implicitly signaled by the gNB to use the constant modulus and/or the Vandermonde-based codebook, for example depending on the size of the resource grant meant for the report transmission. The WTRU may be implicitly signaled (e.g., by the gNB) to use (e.g., either of) the constant modulus and/or the Vandermonde-based codebook, for example depending on the size of the resource grant meant for the report transmission. A larger grant size may indicate constant modulus method. A smaller grant may indicate that the gNB is requesting a Vandermonde-based codebook derived. Alternatively, or additionally, a smaller grant may indicate that the gNB is requesting a codebook-based CSI report. In an example, the choice between constant modulus and Vandermonde-based methods may (e.g., also) be implicitly signaled, for example using the duration between the request and/or the scheduled reporting start time and/or periodicity (e.g., in a case of periodic reporting). In another example, the constant modulus method may be computationally more intensive than the Vandermonde-based method. The constant modulus method may require a larger gap between the request and/or the response and/or periodicity between subsequent reports (e.g., in a case of periodic reporting).

The indication of HBF type and/or precoders may be explicit. The WTRU may be explicitly signaled/configured (e.g., by the gNB) to use the constant modulus and/or the Vandermonde-based method, for example for CSI reporting. The indication of HBF type and/or precoders may be contained in the PDCCH, for example via RRC signaling and/or via MAC-CE signaling. In an example, (e.g., an indication of) HBF type and/or precoders may be contained in the PDCCH (e.g., either via RRC signaling or via MAC-CE signaling). In another example, the time when the new configuration comes into effect may be signalled explicitly and/or the WTRU may use a pre-configured default value. The time when the new configuration comes into effect may be either signalled explicitly, or the WTRU may use a pre-configured default value. The codebook and/or the Vandermonde based methods may use the same or a different number of resources for reporting. The WTRU may include a special indicator of each chosen type, for example if both the codebook and the Vandermonde based methods use the same number of resources for reporting. The Vandermonde-based codebook may have a dynamic design. For example, the proposed HBF Type V may exhibit favorable performance-overhead tradeoff as each FRF vector may require reporting of only one phase to generate. In another example, the feedback overhead may be determined by how the resulting Vandermonde-based phases are quantized.

A (e.g., each) Vandermonde angle value may be quantized. Each angle may be sent back in a T+Q bit bitstream, for example with the following format:

$${t}_{T - 1} … {t}_{0} {q}_{Q - 1} … {q}_{0}$$

where T bits are used to represent the quantization type table/equation and Q bits are used to represent the quantized value or index to a lookup table. The quantization type may be reported at a longer duration, for example based on WTRU measurements. The WTRU may indicate one or more different quantization types, for example based on channel variations. In an example, the non-negative integer values are defined as quantization type t_{T-1} . . . t₀. In another example, the non-negative integer values are defined as a quantized value q=q_{Q-1} . . . q₀. Various values may be pre-defined. In some examples, (e.g., only) the value T (e.g., needs to) may be predefined. In another example, different quantization types may use different Q values, for example, based on a required resolution. For example, if T=2, there may be up to 4 quantization types. In another example, type to may be reserved for absolute quantization. The remaining T−1 (t_{T-1} . . . t₁) types may be used for relative quantization, which may be, for example, centered around the previous value of the angle known to one or more (e.g., both) sides of communication. The WTRU may use a variable T. In an example, the WTRU may use a variable T that may depend on the value of t.

Absolute, delta, and/or central angles quantization may be determined. Absolute (e.g., central) angles quantization may be used, for example when the angle values are sent for the first time and/or (e.g., just) after the communication has been recovered from a failure. In an example, the angle resolution in this case may be determined as in equation (11).

$$Δ α = \frac{2 π}{{2}^{Q}} \qquad ( 11 )$$

For example, if Q is 4, the absolute angle may be specified with a resolution of π/8. In an example, at the receiving side, the actual angle may be calculated using the received q value as in equation (12)

$$α = \frac{2 π q}{{2}^{Q}} \qquad ( 12 )$$

Relative angles quantization may be determined. For example, relative angles quantization may play an important role in determining the feedback overhead and/or the performance. The variations in Vandermonde angles over time may be related to the degree of time-variation of the channel. For example, the variations in Vandermonde angles over time may be implicitly tied to how time-varying the channel is. The WTRU may be configured to determine a range of angles around the determined central angles, for example, constructing a subset of phases with a chosen resolution. The WTRU may choose to (e.g., iteratively) send an update and/or shift of the measured angle reported in the previous slot. The (e.g., remaining) T−1 relative angle quantization types may be based on a table and/or a formula. An angle adjustment δ may be obtained, for example from a table and/or calculated using a formula. The actual angle may be (e.g., iteratively) updated as αᵢ=αᵢ₋₁+δ where αᵢ₋₁ may represent the previous value of the angle. A known predefined lookup table may be used to get the angle adjustment value δ, for example, in table-based relative quantization.

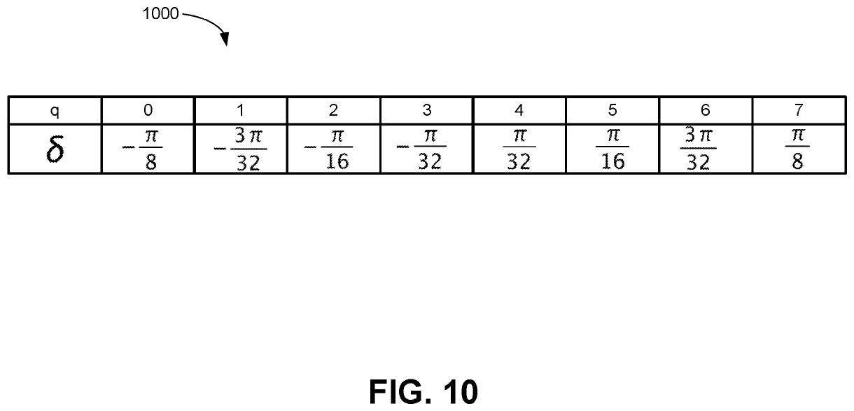

FIG. 10 illustrates an example of a table 1000 that may be used for one of the predefined quantization types, for example with Q=3. The values in the table may be arranged linearly and/or non-linearly. For example, there may be higher resolution near zero and/or lower resolution as we get farther away from zero. A predefined formula may be used to calculate δ from q, for example in a formula based relative quantization. Although the table 1000 illustrates q values of 0 through 7, q may be any value (e.g., number). Additionally, or alternatively, δ may be calculated based on any value of q.

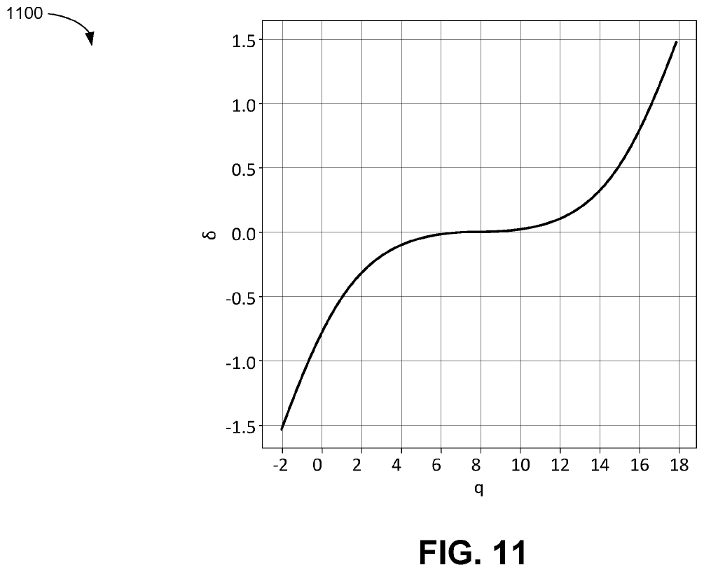

FIG. 11 illustrates an example of a graph 1100 that depicts a scenario where Q=4, and the predefined formula used to calculate & from q is as in equation (13).

$$δ = \frac{π}{2048} {( q - 8 )}^{3} \qquad ( 13 )$$

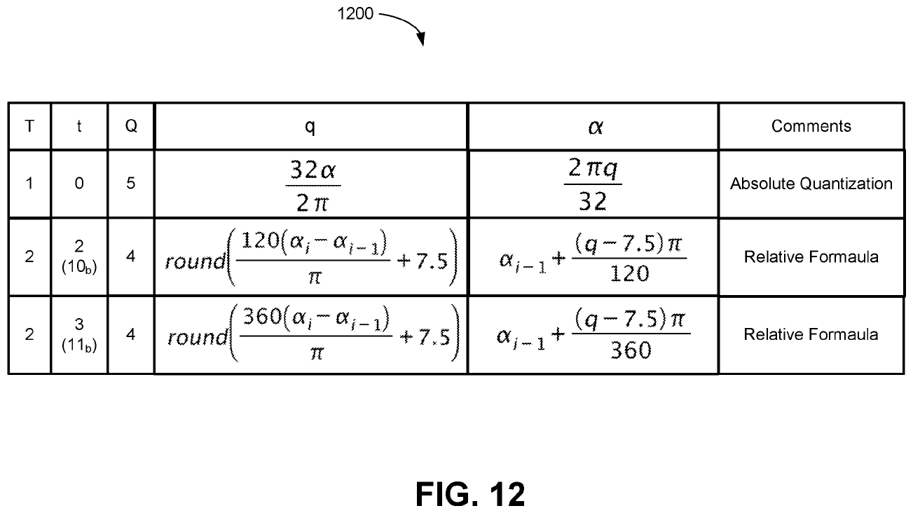

FIG. 12 illustrates an example of a table 1200 that depicts examples of outcomes of the formula as in equation (13). For example, when Q=5 there may be absolute quantization. When Q=4, there may be a relative formula.

A transmitter procedure may be performed. For example, a transmitter procedure may be performed a first time, periodically, and/or when recovering from failure. A WTRU may use the quantization type t₀, for example to report the absolute/central angle. The WTRU may select between different quantization types, for example for relative angle reporting based on predefined thresholds. The WTRU may use the following procedure to determine the quantization type. In an example, at the start of communication, and/or periodically, the WTRU may use quantization type to (t=0). In another example, the WTRU may perform the following:

$if \vert {α}_{i -} {α}_{i - 1} \vert \geq \frac{π}{16} , then use t = 0$
$Else if \vert {α}_{i -} {α}_{i - 1} \vert \geq \frac{π}{48} , then use t = 2$
Else use t = 3

The WTRU may determine a set of angles around ac, for example based on channel measurements. Additionally, or alternatively, the WTRU may determine a set of angles around ac, based on a determined absolute and/or central angle α_{c}. For example, the WTRU may determine a set of uniformly quantized angles between α_{c}+δα and α_{c}−δα with a quantization step α_{q}. The values of δα and/or α_{q} may be chosen from preconfigured values. For example, δα may be chosen from (e.g., four) different preconfigured values, (e.g., 5°, 10°, 15°, 20°, and/or the like). For example, δα may be chosen from (e.g., four) different preconfigured values that may require (e.g., two) bits to indicate. In an example, the quantization step α_{q} may be chosen from predetermined values (e.g., 0.5°, 1°, and/or the like).

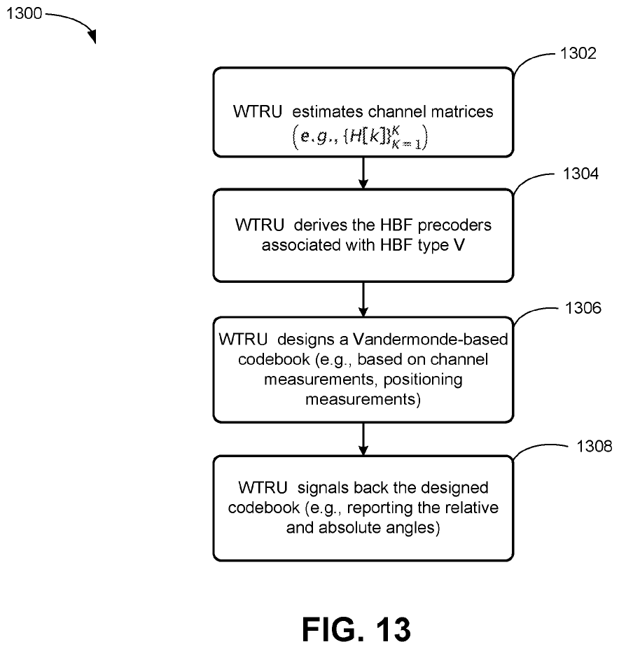

The set boundary and/or the quantization step may be determined by a WTRU, for example based on channel measurements. The WTRU may determine δα and/or α_{q} based on the estimated Doppler and/or the measured coherence time of the channel. In an example, a higher coherence time may yield a smaller variation in the channel which, for example may (e.g., in turn) result in smaller δα. The WTRU may determine δα, for example based on tracking the changes in the estimated angle of arrival and/or by performing positioning related measurements based on positioning reference signals (PRS). The WTRU may determine δα and/or α_{q} (e.g., based on the allocated payload size), for example for reporting Type V weights. FIG. 13 illustrates an example of WTRU procedures 1300 for adaptive Vandermonde-based codebook design. In an example, FIG. 13 highlights the WTRU procedures for adaptively designing and/or reporting the Vandermonde-based codebook. At 1302, the WTRU may estimate a channel matrix, H[k]. The channel matrix, H[k] may be associated with the k-th sub-band, where k=1, . . . , K. In an example at 1304, the WTRU may derive analog and/or hybrid precoders associated with configured HBF Types (e.g., U-unity magnitude, C-codebook based, V-Vandermonde constrained, and/or the like). At 1306, the WTRU may perform procedures for (e.g., adaptive) Vandermonde-based codebook design (e.g., based on channel measurements and/or positioning measurements). The WTRU may, for example at 1308, signal back the (e.g., designed) codebook (e.g., reporting the relative and/or absolute angles).

A WTRU may be configured with one or more triggers, for example for a HBF Type V parameters/codebook update (e.g., Vandermonde-based codebook). The WTRU may be triggered to select/update the Vandermonde-based codebook, for example based on a preconfigured threshold (e.g., number of consecutive NACKS or a target BLER) and/or based on the UCI allocation for the HBF report. A change in the UCI allocation associated with the HBF reporting may trigger the WTRU to adapt the Vandermonde-based codebook parameters (e.g., relative angles), for example to fit to the new UCI allocation. Triggering the WTRU to adapt the Vandermonde-based codebook parameters may occur, for example where the PDSCH performance is good and/or a low resolution codebook may maintain the same performance with a reduced overhead. The WTRU may report the modified codebook parameters (e.g., relative or/and absolute angles), for example to a gNB. The WTRU may transmit (e.g., send) a trigger codebook update message, for example prior to sending the update information. The WTRU may inform the gNB of the proposed updates using a codebook update message, for example a HBF-Vcodebookupdate. The codebook update message may be included with (e.g., be part of) one or more of UCI, PUCCH, PUSCH, and MAC CE. The proposed updates may include all or part of the codebook parameter(s).

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, terminal, base station, RNC, or any host computer.

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories.

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the exemplary embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (“RAM”)) or non-volatile (e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

The foregoing detailed description has set forth various embodiments of the devices and/or processes via the use of block diagrams, flowcharts, and/or examples.

Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or (e.g., virtually) any combination thereof. Suitable processors include, by way of example, a general purpose processor, a special purpose processor, a conventional processor, a digital signal processor (DSP), a plurality of microprocessors, one or more microprocessors in association with a DSP core, a controller, a Products (ASSPs); Field Programmable Gate Arrays (FPGAs) circuits, any other type of integrated circuit (IC), and/or a state machine.

Although features and elements are provided above in particular combinations, each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

It is also to be understood that the terminology used herein is for the purpose of describing particular embodiments only, and is not intended to be limiting.

In certain representative embodiments, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, or alternatively, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved.

Although the invention is illustrated and described herein with reference to specific embodiments, the invention is not intended to be limited to the details shown. Rather, various modifications may be made in the details within the scope and range of equivalents of the claims and without departing from the invention.

Throughout the disclosure, one of skill understands that certain representative embodiments may be used in the alternative or in combination with other representative embodiments.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a UE, WTRU, terminal, base station, RNC, or any host computer.

Suitable processors include, by way of example, a general purpose processor, a special purpose processor, a conventional processor, a digital signal processor (DSP), a plurality of microprocessors, one or more microprocessors in association with a DSP core, a controller, a Products (ASSPs); Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, Mobility Management Entity (MME) or Evolved Packet Core (EPC), or any host computer. The WTRU may be used in conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Although the invention has been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

What is claimed is:

1-20. (canceled)

21. A method performed by a wireless transmit/receive unit (WTRU), the method comprising:
receiving configuration information related to hybrid beamforming (HBF) processing;
determining a channel matrix associated with a sub-band;
deriving one or more HBF precoders using the channel matrix, wherein the HBF precoders are associated with the at least one constraint related to processing performance or feedback overhead;
determining a preferred HBF type based on a preconfigured set of parameters associated with the configuration information related to HBF processing, wherein the preferred HBF type is a unity magnitude HBF type, a codebook based HBF type, or a Vandermonde constrained HBF type; and
reporting, based on a first configuration related to HBF processing and the at least one constraint related to processing performance or feedback overhead associated with each of the plurality of HBF types, to a base station HBF information related to the preferred HBF type and associated parameters, wherein the HBF information indicates one or more of the preferred HBF Type, a HBF precoder associated with the preferred HBF type, or an effective rank associated with the preferred HBF type.

22. The method of claim 21, wherein the configuration information related to HBF processing comprises one or more of a payload size for reporting HBF-related information, a number of layers, a PRG size, a HBF Type, or an effective rank.

23. The method of claim 21, wherein the reporting to the base station further comprises reporting a Vandermonde based precoder derived from one or more measurements made by the WTRU.

24. The method of claim 23, wherein the Vandermonde based precoder is derived from among a plurality of Vandermonde based precoders.

25. The method of claim 21, wherein the configuration information is first configuration information, the method further comprising:
receiving a second configuration in response to the HBF information, wherein the second configuration comprises information related to the preferred HBF type or another HBF type; and
performing HBF processing based on the second configuration.

26. The method of claim 25, wherein the preferred HBF type comprises a first preferred HBF type, the method further comprising:
switching, based on the second configuration and the at least one constraint related to processing performance or feedback overhead associated with each of the plurality of HBF types, from the first preferred HBF type to a second preferred HBF type of the plurality of HBF types; and
reporting to the base station second HBF information related to the second preferred HBF type of the plurality of HBF types and associated parameters, wherein the second HBF information indicates at least one of the second preferred HBF Type, an HBF precoder associated with the second preferred HBF type, or an effective rank associated with the second preferred HBF type.

27. The method of claim 26, wherein switching from the from the first preferred HBF type to a second preferred HBF type of the plurality of HBF types is based on a trigger event.

28. The method of claim 27, wherein the trigger event comprises satisfying one or more of a performance threshold value, a threshold associated with a monitored value, and a preconfigured condition.

29. The method of claim 21, further comprising deriving the first configuration related to HBF processing based on one or more measurements made by the WTRU.

30. The method of claim 21, wherein the at least one constraint related to processing performance or feedback overhead comprises a measured angle.

31. A wireless transmit/receive unit (WTRU), the WTRU comprising:
a processor configured to:
receive configuration information related to hybrid beamforming (HBF) processing;
determine a channel matrix associated with a sub-band;
derive one or more HBF precoders using the channel matrix, wherein the HBF precoders are associated with the at least one constraint related to processing performance or feedback overhead;
determine a preferred HBF type based on a preconfigured set of parameters associated with the configuration information related to HBF processing, wherein the preferred HBF type is a unity magnitude HBF type, a codebook based HBF type, or a Vandermonde constrained HBF type; and
report, based on a first configuration related to HBF processing and the at least one constraint related to processing performance or feedback overhead associated with each of the plurality of HBF types, to a base station HBF information related to the preferred HBF type and associated parameters, wherein the HBF information indicates one or more of the preferred HBF Type, a HBF precoder associated with the preferred HBF type, or an effective rank associated with the preferred HBF type.

32. The WTRU of claim 31, wherein the configuration information related to HBF processing comprises one or more of a payload size for reporting HBF-related information, a number of layers, a PRG size, a HBF Type, or an effective rank.

33. The WTRU of claim 31, wherein being configured to report to the base station further comprises being configured to report a Vandermonde based precoder derived from one or more measurements made by the WTRU.

34. The WTRU of claim 33, wherein the Vandermonde based precoder is derived from among a plurality of Vandermonde based precoders.

35. The WTRU of claim 31, wherein the configuration information is first configuration information, the processor further configured to:
receive a second configuration in response to the HBF information, wherein the second configuration comprises information related to the preferred HBF type or another HBF type; and
perform HBF processing based on the second configuration.

36. The WTRU of claim 35, wherein the preferred HBF type comprises a first preferred HBF type, the processor further configured to:
switch, based on the second configuration and the at least one constraint related to processing performance or feedback overhead associated with each of the plurality of HBF types, from the first preferred HBF type to a second preferred HBF type of the plurality of HBF types; and
report to the base station second HBF information related to the second preferred HBF type of the plurality of HBF types and associated parameters, wherein the second HBF information indicates at least one of the second preferred HBF Type, an HBF precoder associated with the second preferred HBF type, or an effective rank associated with the second preferred HBF type.

37. The WTRU of claim 36, wherein being configured to switch from the from the first preferred HBF type to a second preferred HBF type of the plurality of HBF types is based on a trigger event.

38. The WTRU of claim 37, wherein the trigger event comprises satisfying one or more of a performance threshold value, a threshold associated with a monitored value, and a preconfigured condition.

39. The WTRU of claim 31, wherein the processor is further configured to derive the first configuration related to HBF processing based on one or more measurements made by the WTRU.

40. The WTRU of claim 31, wherein the at least one constraint related to processing performance or feedback overhead comprises a measured angle.
